(19) United States
(12) Patent Application Publication
(10) Pub. No.: US 2017/0363256 A1
(43) Pub. Date: Dec. 21, 2017

(54) LIGHT-EMITTING DIODE CONNECTION MODULE

(71) Applicant: HON HAI PRECISION INDUSTRY CO., LTD., New Taipei (TW)

(72) Inventors: CHANG-DA HO, New Taipei (TW); YI-CHENG LIN, New Taipei (TW)

(21) Appl. No.: 15/291,156

(22) Filed: Oct. 12, 2016

(30) Foreign Application Priority Data
Jun. 17, 2016 (TW) 105119031

(51) Int. Cl. F21K 9/61; F21V 23/00; F21V 21/096; F21V 8/00; F21V 23/04; F21Y 2115/10

(52) U.S. Cl. CPC F21K 9/61; G02B 6/0008; F21V 23/04; F21V 23/002; F21V 21/096; F21Y 2115/10

(57) ABSTRACT

An LED connection module comprises a plurality of LED connection units. Each of the LED connection unit comprises an LED pillar and a housing connected to the LED pillar. The LED pillar comprises a plug. The housing comprises an upper surface and at least one lateral surface. The housing comprising a socket. The socket is defined on the upper surface of the housing. The plug is matching with the shape of the socket to control a power-on mode and a power-off mode of the LED pillar by way of plugging and unplugging. The housing comprises at least one magnet. The at least one magnet is located inside the housing. The housings are attached to each other by interaction forces of the magnets.

### CROSS-REFERENCE TO RELATED APPLICATIONS

This application claims priority to Taiwanese Patent Application No. 105119031 filed on Jun. 17, 2016 in the Taiwan Intellectual Property Office, the contents of which are incorporated by reference herein.

### FIELD

The subject matter herein generally relates to a light-emitting diodes.

### BACKGROUND

Light emitting diodes (LEDs) are widely used in lighting applications.

The connection module for an LED is usually embedded in a container. Currently, a plurality of LED connection units in the LED connection module is irregularly arranged, resulting in low efficiency in the space used. Additionally, the current assembly of a housing and an LED pillar of the LED connection unit is also inconvenient.

### SUMMARY

An LED connection module that can effectively use container space and can be easily assembled is disclosed.

The LED connection module comprises a plurality of LED connection units. Each of the LED connection unit comprises an LED pillar and a housing connected to the LED pillar. The LED pillar comprises a plug. The housing comprises an upper surface and at least one lateral surface. The at least one lateral surface is perpendicular to the upper surface. The housing comprises a socket. The upper surface comprises a depression. The housing is substantially hollow. The socket is defined on the upper surface of the housing. The socket extends from the depression of the upper surface to an interior portion of the substantially hollow housing. The plug is matching with the shape of the socket to control a power-on mode and a power-off mode of the LED pillar by way of plugging and unplugging. The housing comprises at least one magnet. The at least one magnet is located inside the housing. The at least one magnet is close to the at least one lateral surface. The housings are attached to each other by interaction forces of the magnets.

The LED connection module (1) uses magnets to make a plurality of LED connection units attach to each other, and minimizes the volume and more effectively uses the space of a container; (2) allows the assembly of the LED pillar to the housing of the LED connection unit to be simpler and easier by simply connecting the LED pillar of the LED connection module through the plug and the socket.

### BRIEF DESCRIPTION OF THE DRAWINGS

Implementations of the present technology will now be described, by way of example only, with reference to the attached figures.

FIG. 1 is a perspective view of an LED connection module according to an exemplary embodiment.

FIG. 2 is a perspective view of an LED connection unit of the LED connection module in FIG. 1.

FIG. 3 is a cross-sectional view along line of the LED connection unit in FIG. 2.

FIG. 4 is a cross-sectional view along line IV-IV of the LED connection unit in FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts have been exaggerated to better illustrate details and features of the present disclosure.

The term “inside” indicates that at least a portion of a region is partially contained within a boundary formed by an object. The term “comprising,” when utilized, means “including, but not necessarily limited to”; it specifically indicates open-ended inclusion or membership in the so-described combination, group, series, and the like.

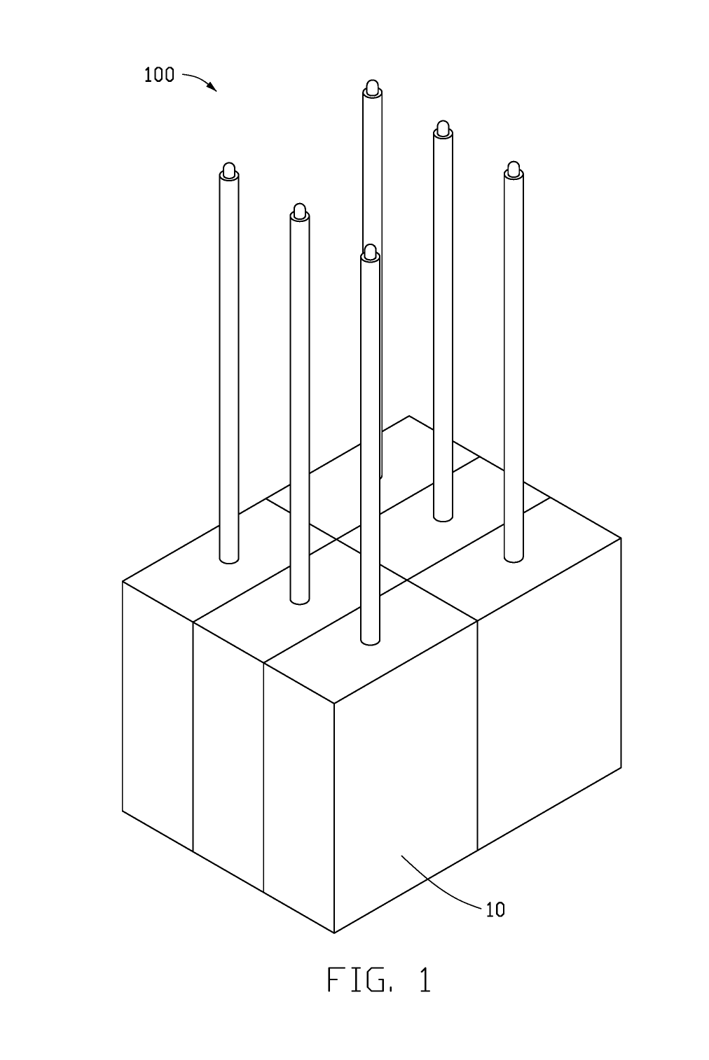

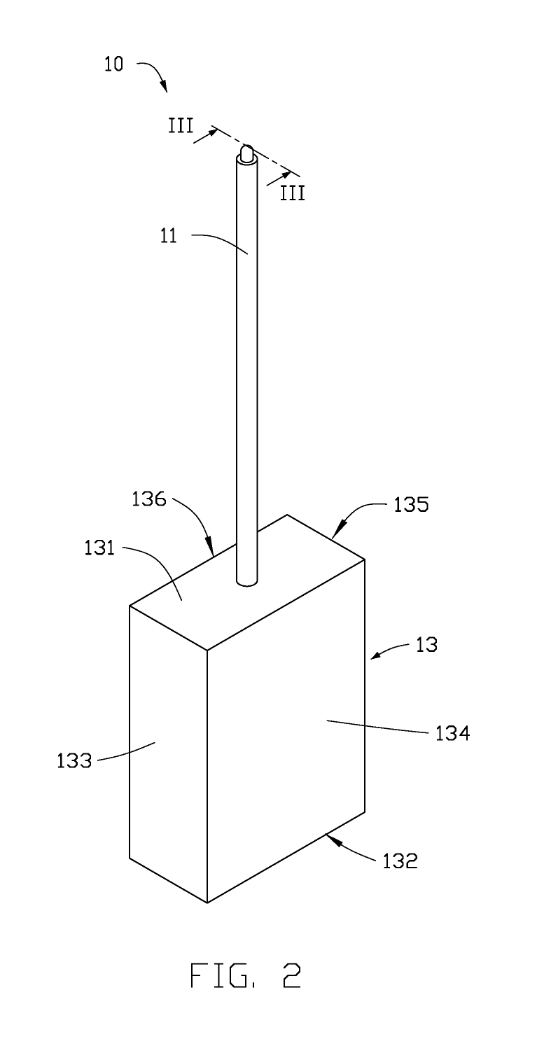

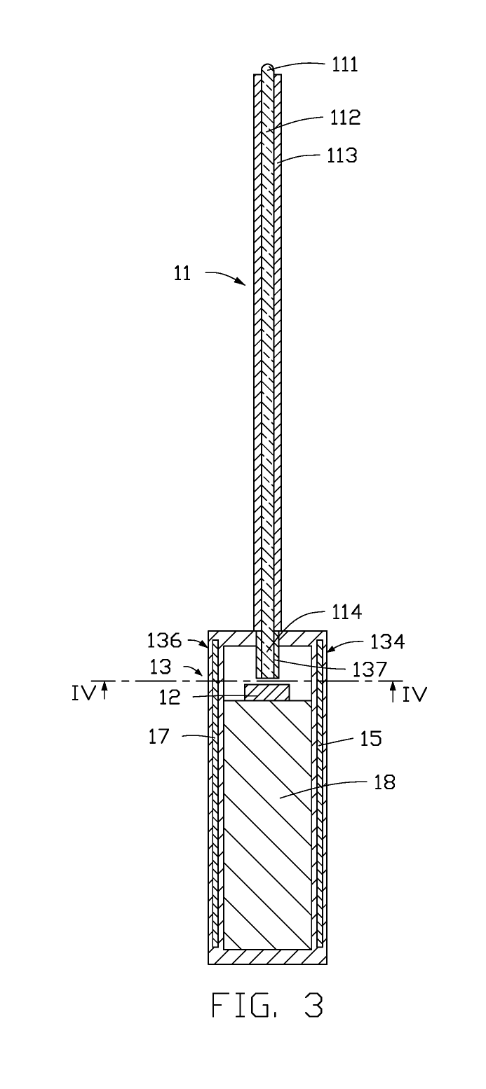

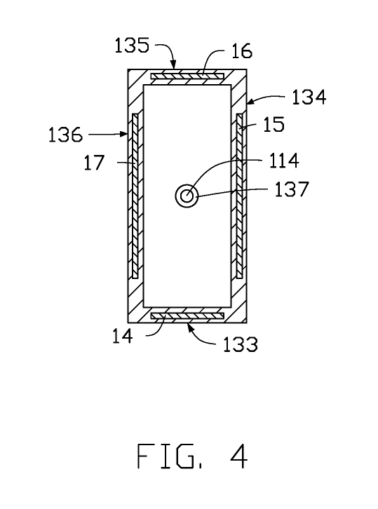

The LED connection module 100 of the present exemplary embodiment will be further described in combination with FIG. 1 to FIG. 4.

FIG. 1 to FIG. 4 show a first exemplary embodiment of an LED connection module 100. The LED connection module 100 comprises a plurality of LED connection units 10. In this exemplary embodiment, the LED connection module 100 comprises 6 LED connection units 10. The 6 LED connection units 10 are attached to each other.

The LED connection unit 10 comprises at least one LED pillar 11, at least one

LED light source 12, and a housing 13 connected to the LED pillar 11. In this exemplary embodiment, one LED pillar 11 supports one LED light source 12.

The LED pillar 11 comprises a head 111, a light-guiding pillar 112, a reflecting layer 113, and a plug 114. The LED pillar 112 comprises a first end 1121 and a second end 1122 opposite to the first end 1121. The first end 1121 and the second end 1122 are separately located at two ends of the light-guiding pillar 112. The head 111 is formed at the first end 1121 of the light-guiding pillar 112; and the plug 114 is formed at the second end 1122 of the light-guiding pillar 112. In this exemplary embodiment, the LED light source 12 is arranged inside the housing 13 and faces the plug 114. The head 111 is made of transparent or translucent material, such as polycarbonate (PC).

The LED light-guiding pillar 112 is used to transmit light. The material of light-guiding pillar is one of the following: PC, polymethyl methacrylate (PMMA), or the like. In this exemplary embodiment, the material of LED light-guiding pillar 112 is PC.

The shape of light-guiding pillar 112 can be cylindrical, prismatic, or other shape.

In this exemplary embodiment, the light-guiding pillar 112 is cylindrical.

The light-reflecting layer 113 is coated around the light-guiding pillar 112 to prevent light leakage. The light-reflecting layer 113 is made of light-reflecting material.

The plug 114 is made of light-guiding material, such as PC, PMMA, or the like. The outer surface of the plug 114 is also coated with a light-reflecting layer to prevent light leakage. In this exemplary embodiment, the material of the plug 114 is PC.

In this exemplary embodiment, the housing 13 is a cuboid. The housing 13 comprises an upper surface 131 and a lower surface 132 opposite to the upper surface 131. The housing 13 further comprises a first lateral surface 133, a second lateral surface 134, a third lateral surface 135, and a fourth lateral surface 136. The first lateral surface 133 perpendicularly intersects the upper surface 131 and the lower surface 132. The second lateral surface 134 perpendicularly intersects the first lateral surface 133. The third lateral surface 135 is arranged opposite to the first lateral surface 133 and perpendicularly intersects the second lateral surface 134. The fourth lateral surface 136 is arranged opposite to the second lateral surface 134 and perpendicularly intersects the third lateral surface 135 and the first lateral surface 133.

The housing 13 comprises a socket 137, and the housing 13 is substantially hollow. The socket 137 is defined on the upper surface 131. The upper surface 131 comprises a depression. The socket 137 extends from the depression of the upper surface 131 to an interior portion of the housing 13. The socket 137 extends downward from the upper surface 131 to the lower surface 132. The socket 137 matches the shape of the plug 114 to control a power-on mode and a power-off mode of the LED pillar 11 by way of plugging and unplugging. The plug 114 is connected to the socket 137 by a simple audio-type connection, and the plug 114 can be plugged and unplugged freely for plug-and-play. The plug 114 has a diameter of about 2.5 mm to about 3.5 mm.

Additionally, the length of the LED pillar 11 can be changed according to the actual needs of users.

The housing 13 comprises at least one magnets. The at least one magnet is located inside the housing 13. The at least one magnet is close to the lateral surface of the housing 13.

In this exemplary embodiment, the housing 13 comprises four magnets. The four magnets includes a first magnet 14, a second magnet 15, a third magnet 16, and a fourth magnet 17. All of the first magnet 14, the second magnet 15, the third magnet 16, and the fourth magnet 17 are respectively positioned on the first lateral surface 133, the second lateral surface 134, the third lateral surface 135, and the fourth lateral surface 136. The first magnet 14 is positioned on the first lateral surface 133. The second magnet 15 is positioned on the second lateral surface 134. The third magnet 16 is positioned on the third lateral surface 135. The fourth magnet 17 is positioned on the fourth lateral surface 136.

The housings 13 of the plurality of the LED connection units 10 are attached to each other both laterally and longitudinally by the interaction forces of magnets between the lateral surfaces. Together, the plurality of the LED connection units 10 forms the LED connection module 100. Specifically, the first lateral surface 133 or the third lateral surface 135 of one housing 13 is attached to the first lateral surface 133 or the third lateral surface 135 of another housing 13 by the first magnet 14 or the third magnet 16. The second lateral surface 134 or the fourth lateral surface 136 of one housing 13 is attached to the second lateral surface 134 or the fourth lateral surface 136 of another housing 13 by the second magnet 15 or the fourth magnet 17.

The housing 13 further includes at least one battery module 18. In this exemplary embodiment, the battery module 18 comprises two 1.5V batteries that function as the electric power source of the whole LED connection unit 10. The housing 13 includes other electric components, such as circuit board (not shown in the figures).

In this exemplary embodiment, the LED light source 12 is constantly emitting light when the plug 114 is plugged into the socket 137. When there is a need to light up the head 111, the plug 114 of the LED pillar 11 is plugged into the socket 137 of the housing 13, and the head 111 of the LED pillar 11 is illuminated. When there is no need for light, the plug 114 of the LED pillar 11 is unplugged from the socket 137 of the housing 13, and the head 111 of the LED pillar 11 is not illuminated.

In other exemplary embodiment, an on/off switch is included to control the LED light source 12. The on/off switch is located on the housing 13 to control the power-on mode and the power-off mode of the LED light source 12. Specifically, when there is a need to light up the head 111, the switch is turned on. When there is no need to light up the head 111, the switch is turned off. For portability and convenience, the LED pillar 11 can still be unplugged from the socket 137 and plugged again when necessary.

A second exemplary embodiment provides an LED connection module. The LED connection module of the second exemplary embodiment is substantially similar to the LED connection module 100 of the first exemplary embodiment. The difference is that the LED light source of the LED connection module of the second exemplary embodiment is located at the head of the LED connection module. In the second exemplary embodiment, the LED light source is electrically connected to the plug of the LED connection unit through a conducting wire. When the plug is plugged into the socket of the LED connection unit, the LED light source is then electrically connected to the circuit board in the housing.

The LED connection module of this disclosure (1) uses magnets to make a plurality of LED connection units attach to each other, and more effectively uses container space; and (2) allows the LED pillar to be freely plugged into and unplugged from the socket for plug-and-play by the connection of the plug and the socket. Further, (3) the length of the LED pillar can be changed according to the actual needs of users without changing the structure of the plug of the LED pillar, hence reducing the manufacture cost of the LED connection unit.

The exemplary embodiments shown and described above are only examples. Many details are often found in the art such as the other features of an LED connection module. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. An LED connection module comprising a plurality of LED connection units, wherein each of the LED connection unit comprises:
an LED pillar, wherein the LED pillar comprises a plug; and
a housing connected to the LED pillar, wherein the housing comprises an upper surface and at least one lateral surface; and wherein the at least one lateral surface is perpendicular to the upper surface;
wherein the housing comprises a socket; the upper surface comprises a depression; the housing is substantially hollow; the socket is defined on the upper surface of the housing; the socket extends from the depression of the upper surface to an interior portion of the substantially hollow housing; and wherein the plug matches the shape of the socket to control a power-on mode and a power-off mode of the LED pillar by way of plugging and unplugging; and
wherein the housing comprises at least one magnet; the at least one magnet is located inside the housing; the at least one magnet is close to the at least one lateral surface; and wherein the housings are attached to each other by interaction forces of the magnets.

2. The LED connection module of claim 1, wherein the LED pillar further comprises:
a head;
a light-guiding pillar; and
a light-reflecting layer;
wherein the light-guiding pillar comprises a first end and a second end; the first end and the second end are separately located at two ends of the light-guiding pillar; the head is formed at the first end of the light-guiding pillar; the plug is formed at the second end of the light-guiding pillar; and wherein the light-reflecting layer is coated around the light-guiding pillar.

3. The LED connection module of claim 1, wherein the housing further comprises a lower surface opposite to the upper surface; and the socket further extends downward from the upper surface to the lower surface.

4. The LED connection module of claim 1, wherein the housing further comprises:
a first lateral surface perpendicularly intersecting the upper surface;
a second lateral surface perpendicularly intersecting the first lateral surface;
a third lateral surface opposite to the first lateral surface and perpendicularly intersecting the second lateral surface; and
a fourth lateral surface opposite to the second lateral surface and perpendicularly intersecting the first lateral surface and the third lateral surface;
wherein the housing comprises four magnets; the four magnets includes a first magnet, a second magnet, a third magnet, and a fourth magnet; and wherein the first magnet, the second magnet, the third magnet, and the fourth magnet are respectively close to the first lateral surface, the second lateral surface, the third lateral surface, and the fourth lateral surface.

5. The LED connection module of claim 1, wherein the plug has a diameter of about 2.5 mm to about 3.5 mm.

6. The LED connection module of claim 1, wherein the LED connection unit further comprises an LED light source; and wherein the LED light source is arranged inside the housing and faces the plug.

7. The LED connection module of claim 6, wherein the LED light source is constantly emitting light when the plug is plugged into the socket.

8. The LED connection module of claim 6, wherein a switch controlling the LED light source is formed on the housing to control the power-on mode and the power-off mode of the LED light source.

9. The LED connection module of claim 1, wherein the LED connection unit further comprises an LED light source; the LED pillar further includes a head; the head is located at one end of the LED pillar away from the plug; and wherein the LED light source is located inside the head.

10. The LED connection module of claim 9, wherein the housing further comprises a circuit board; and wherein the LED light source electrically connects to the circuit board through a conducting wire when the LED pillar is plugged into the socket.
